(19) United States
(12) Patent Application Publication
(10) Pub. No.: US 2013/0046556 A1
(43) Pub. Date: Feb. 21, 2013

(54) MEDICAL PRESENTATION CREATOR

(71) Applicants: Vijaykalyan Yeluri, Campbell, CA (US); Perry Frederick, Palo Alto, CA (US); Robert John Herfkens, Stanford, CA (US)

(72) Inventors: Vijaykalyan Yeluri, Campbell, CA (US); Perry Frederick, Palo Alto, CA (US); Robert John Herfkens, Stanford, CA (US)

(21) Appl. No.: 13/212,394

(22) Filed: Aug. 18, 2011

(51) Int. Cl. G06Q 50/00

(52) U.S. Cl. 705/3

(57) ABSTRACT

An example computer-implemented method for creating a medical presentation. The method includes accessing a medical exam, presenting the medical exam for review by a user, and marking at least a portion of the medical exam according to a criterion identified by the user. The method includes collecting the marked portion of the medical exam to be included in a presentation according to the criterion, and preparing, automatically, a presentation for the user as the user continues exam review, the presentation including the marked portion of the medical exam, wherein the marked portion of the medical exam is anonymized, the presentation to be dynamically updated as the user continues review.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medication orders, medical histories, imaging data, test results, diagnosis information, management information, and/or scheduling information, for example.

Healthcare providers, such as radiologists, may wish to create medical presentations for teaching purposes and/or medical conferences using information gathered and stored in the healthcare environments. For example, healthcare providers may wish to use imaging data, test results, and/or diagnosis information associated with a patient in a medical presentation. To use the medical data and/or test results in a presentation, a healthcare provider must ensure that patient identifying information has been removed to protect the privacy of the patient.

### BRIEF SUMMARY

Certain examples provide methods, systems, and tangible computer-readable media for a medical presentation creator. Certain examples provide a computer-implemented method for creating a medical presentation. The method includes accessing a medical exam, presenting the medical exam for review by a user, and marking at least a portion of the medical exam according to a criterion identified by the user. The method includes collecting the marked portion of the medical exam to be included in a presentation according to the criterion, and preparing, automatically, a presentation for the user as the user continues exam review, the presentation including the marked portion of the medical exam, wherein the marked portion of the medical exam is anonymized, the presentation to be dynamically updated as the user continues review.

Certain examples provide a medical presentation creator system. The system includes a medical exam accessor to access a medical exam and an exam presenter to present the medical exam for review by a user. The system includes an exam marker to mark at least a portion of the medical exam according to a criterion identified by the user and a medical data collector to collect the marked portion of the medical exam to be included in a presentation according to the criterion. The system includes a presentation preparer to prepare, automatically, a presentation for the user as the user continues exam review, the presentation including the marked portion of the medical exam, wherein the marked portion of the medical exam is anonymized, the presentation to be dynamically updated as the user continues review.

Certain examples provide a tangible computer-readable medium comprising instructions that, when executed, cause a computing device to at least access a medical exam, present the medical exam for review by a user, and mark at least a portion of the medical exam according to a criterion identified by the user. The tangible computer-readable medium comprises instructions that, when executed, cause a computing device to at least collect the marked portion of the medical exam to be included in a presentation according to the criterion and prepare, automatically, a presentation for the user as the user continues exam review, the presentation including the marked portion of the medical exam, wherein the marked portion of the medical exam is anonymized, the presentation to be dynamically updated as the user continues review.

### BRIEF DESCRIPTION OF SEVERAL VIEWS OF THE DRAWINGS

FIG. 1 illustrates a block diagram of an example medical presentation creator in an example healthcare system.

FIG. 2A illustrates an example patient medical image collected by the example healthcare system of FIG. 1 to be included in a medical presentation created using the example medical presentation creator of FIG. 1.

FIG. 2B illustrates an example patient medical image created by the example medical presentation creator of FIG. 1.

FIG. 3 is a flow diagram illustrating an example user protocol for using the example medical presentation creator of FIG. 1.

FIG. 4 shows a block diagram of the example medical presentation creator of FIG. 1.

FIG. 5 illustrates a flow diagram for an example method of implementing the example medical presentation creator of FIG. 4.

FIG. 6 shows a block diagram of an example processor system that may be used to implement systems and methods described herein.

The foregoing summary, as well as the following detailed description of certain examples of the present invention, will be better understood when read in conjunction with the appended drawings. For the purpose of illustrating the invention, certain examples are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, and tangible computer-readable media including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, and tangible computer-readable media, the examples provided are not the only way to implement such methods, systems, and tangible computer-readable media.

When any of the appended claims are read to cover a purely software and/or firmware implementation, in an embodiment, at least one of the elements is hereby expressly defined to include a tangible medium. As used herein, the term tangible computer readable medium is expressly defined to include any type of computer readable storage and to exclude propagating signals. Additionally or alternatively, the example methods, systems, and tangible computer-readable media may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

In a healthcare environment, medical data such as exam worklists, patient historical palettes, medical reports, and medical images, etc. are created, gathered, and stored in a healthcare information system. For example, a medical exam may be performed and stored upon receipt of an order corresponding to the medical exam to be performed. A healthcare provider, such as a radiologist, may wish to create a medical presentation with the medical exam to be used in a teaching capacity and/or at a medical conference, for example. It is important for the healthcare provider to remove any patient-identifying information from the medical exam for inclusion in a medical presentation.

To create an anonymized medical exam in prior systems, a healthcare provider may send a medical exam from a Picture Archiving and Communication System (PACS) to a Digital Imaging and Communications in Medicine (DICOM) receiver to anonymize the exam. A separate anonymized exam is created in the DICOM receiver and may be sent to the PACS for access by the healthcare provider. This workflow to create a medical presentation is cumbersome and time consuming for the healthcare provider. The healthcare provider performs multiple manual steps to convert a medical exam of interest to an anonymized exam appropriate for presentation. Additionally, because a separate anonymized exam is created and sent to the PACS, the anonymized exam does not contain or have direct access to any associated reports or data contained in the original non-anonymized exam. This workflow creates an anonymized duplicate of the medical exam to be stored in the PACS and this anonymized duplicate is imported into the PACS without a corresponding order from the RIS. Thus, a PACS administrator must manually create a new order to correspond to this anonymized duplicate exam. Therefore, it is desirable to create a medical presentation workflow that allows a healthcare provider to automatically create an anonymized medical presentation as part of a standard workflow.

In certain examples, a medical presentation creator accesses a medical exam. The medical exam may be selected by a user, such as a healthcare provider, via, for example a viewer or user interface. In an alternative example, the medical exam is automatically selected from a worklist associated with the user. The medical exam may be one of, for example, an exam worklist, a patient historical palette, a medical report, or a medical image, etc. The accessed medical exam is presented on the viewer or user interface for review by the user. Where at least a portion of the medical exam is of interest for a particular type of medical presentation, the user may mark the medical exam, indicating the relevant type of medical presentation. The relevant type of medical presentation may be selected according to a type of medical identifier or characteristic.

In certain examples, the medical presentation creator collects the marked portions of the medical exam to be included in a medical presentation according to the particular type of medical presentation. The medical presentation prepares, automatically, a medical presentation for the user using the marked portions of the medical exam. In preparing the medical presentation, the medical presentation creator anonymizes the marked portions of the medical exam to exclude any patient-identifying information.

In certain examples, the medical presentation prepares, automatically, the medical presentation for the user as the user continues additional medical exam review. The user may mark additional medical exams according to the same or a different type of medical presentation. The medical presentation may be dynamically updated as the user continues review of additional medical exams. The medical presentation may be displayed for the user via an interface and may be shared with one or more additional users for viewing and/or editing.

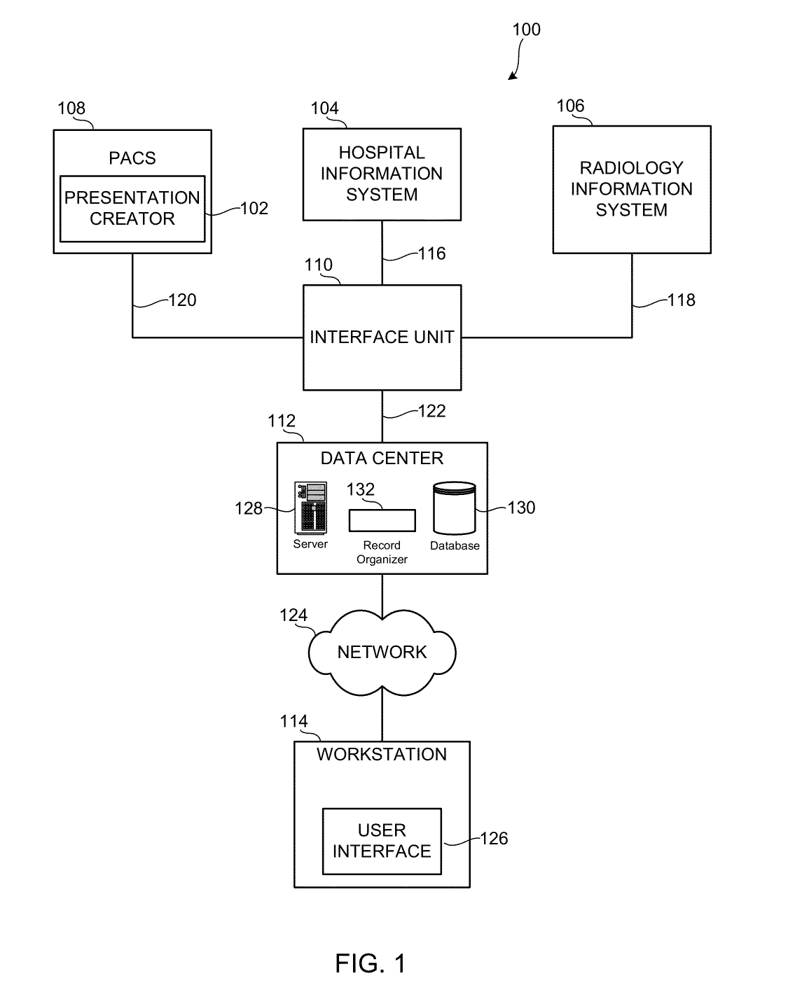

FIG. 1 shows a block diagram of an example healthcare system 100 capable of implementing an example medical presentation creator 102. The example healthcare system 100 includes the example medical presentation creator 102, a hospital information system (HIS) 104, a radiology information system (RIS) 106, a picture archiving and communication system (PACS) 108, an interface unit 110, a data center 112, and a workstation 114. In the illustrated example, the HIS 104, the RIS 106, and the PACS 108 are housed in a healthcare facility and locally archived. However, in other implementations, the HIS 104, the RIS 106, and/or the PACS 108 can be housed one or more other suitable locations. In certain implementations, one or more of the PACS 108, RIS 106, HIS 104, etc., can be implemented remotely via a thin client and/or downloadable software solution. Furthermore, one or more components of the healthcare system 100 can be combined and/or implemented together. For example, the RIS 106 and/or the PACS 108 can be integrated with the HIS 104; the PACS 108 can be integrated with the RIS 106; and/or the three example information systems 104, 106, and/or 108 can be integrated together. In other example implementations, the healthcare system 100 includes a subset of the illustrated information systems 104, 106, and/or 108. For example, the healthcare system 100 can include only one or two of the HIS 104, the RIS 106, and/or the PACS 108. Information (e.g., scheduling, test results, observations, diagnosis, etc.) can be entered into the HIS 104, the RIS 106, and/or the PACS 108 by healthcare practitioners (e.g., radiologists, physicians, and/or technicians) before and/or after patient examination.

The HIS 104 stores medical information such as clinical reports, patient information, and/or administrative information received from, for example, personnel at a hospital, clinic, and/or a physician's office. The RIS 106 stores information such as, for example, radiology reports, messages, warnings, alerts, patient scheduling information, patient demographic data, patient tracking information, and/or physician and patient status monitors. Additionally, the RIS 106 enables exam order entry (e.g., ordering an x-ray of a patient) and image and film tracking (e.g., tracking identities of one or more people that have checked out a film). In some examples, information in the RIS 106 is formatted according to the HL-7 (Health Level Seven) clinical communication protocol.

The PACS 108 stores medical images (e.g., x-rays, scans, three-dimensional renderings, etc.) as, for example, digital images in a database or registry. In some examples, the medical images are stored in the PACS 108 using the Digital Imaging and Communications in Medicine (“DICOM”) format. Images are stored in the PACS 108 by healthcare practitioners (e.g., imaging technicians, physicians, radiologists) after a medical imaging of a patient and/or are automatically transmitted from medical imaging devices to the PACS 108 for storage. In some examples, the PACS 108 can also include a display device and/or viewing workstation to enable a healthcare practitioner or provider to communicate with the PACS 108.

The interface unit 110 includes a hospital information system interface connection 116, a radiology information system interface connection 118, a PACS interface connection 120, and a data center interface connection 122. The interface unit 110 facilities communication among the HIS 104, the RIS 106, the PACS 108, and/or the data center 112. The interface connections 116, 118, 120, and 122 can be implemented by, for example, a Wide Area Network (“WAN”) such as a private network or the Internet. Accordingly, the interface unit 110 includes one or more communication components such as, for example, an Ethernet device, an asynchronous transfer mode (“ATM”) device, an 802.11 device, a DSL modem, a cable modem, a cellular modem, etc. In turn, the data center 112 communicates with the workstation 114, via a network 124, implemented at a plurality of locations (e.g., a hospital, clinic, doctor's office, other medical office, or terminal, etc.). The network 124 is implemented by, for example, the Internet, an intranet, a private network, a wired or wireless Local Area Network, and/or a wired or wireless Wide Area Network. In some examples, the interface unit 110 also includes a broker (e.g., a Mitra Imaging's PACS Broker) to allow medical information and medical images to be transmitted together and stored together.

The interface unit 110 receives images, medical reports, administrative information, and/or other clinical information from the information systems 104, 106, 108 via the interface connections 116, 118, 120. If necessary (e.g., when different formats of the received information are incompatible), the interface unit 110 translates or reformats (e.g., into Structured Query Language (“SQL”) or standard text) the medical information, such as medical reports, to be properly stored at the data center 112. The reformatted medical information can be transmitted using a transmission protocol to enable different medical information to share common identification elements, such as a patient name or social security number. Next, the interface unit 110 transmits the medical information to the data center 112 via the data center interface connection 122. Finally, medical information is stored in the data center 112 in, for example, the DICOM format, which enables medical images and corresponding medical information to be transmitted and stored together.

The medical information is later viewable and easily retrievable at the workstation 114 (e.g., by their common identification element, such as a patient name or record number). The workstation 114 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstation 114 receives commands and/or other input from a user via, for example, a keyboard, mouse, track ball, microphone, etc. The workstation 114 is capable of implementing a user interface 126 to enable a healthcare practitioner to interact with the healthcare system 100. For example, in response to a request from a physician, the user interface 126 presents a patient medical history.

The example data center 112 of FIG. 1 is an archive to store information such as, for example, images, data, medical reports, and/or, more generally, patient medical records. In addition, the data center 112 can also serve as a central conduit to information located at other sources such as, for example, local archives, hospital information systems/radiology information systems (e.g., the HIS 104 and/or the RIS 106), or medical imaging/storage systems (e.g., the PACS 108 and/or connected imaging modalities). That is, the data center 112 can store links or indicators (e.g., identification numbers, patient names, or record numbers) to information. In the illustrated example, the data center 112 is managed by an application server provider (“ASP”) and is located in a centralized location that can be accessed by a plurality of systems and facilities (e.g., hospitals, clinics, doctor's offices, other medical offices, and/or terminals). In some examples, the data center 112 can be spatially distant from the HIS 104, the RIS 106, and/or the PACS 108 (e.g., at General Electric® headquarters).

The example data center 112 of FIG. 1 includes a server 128, a database 130, and a record organizer 132. The server 128 receives, processes, and conveys information to and from the components of the healthcare system 100. The database 130 stores the medical information described herein and provides access thereto. The example record organizer 132 of FIG. 1 manages patient medical histories, for example. The record organizer 132 can also assist in procedure scheduling, for example.

In certain examples, the medical presentation creator 102 is located in the PACS 108. In an alternative example, the presentation creator 102 may be located separately or may be included in any other suitable device of the healthcare system 100. In operation, the example medical presentation creator 102 accesses a medical exam. The medical exam may be stored in the data center 112 or located in any other component of the healthcare system 100. The medical exam to be accessed by the presentation creator 102 may be selected by a user via a viewer, such as the user interface 126 of the workstation 114. In an alternative example, the medical exam may be automatically selected from a worklist associated with the user. The example presentation creator 102 presents the medical exam for review by the user via a viewer, such as the user interface 126. In an alternative example, the medical exam may be presented at a viewer associated with the PACS 108.

The example medical presentation creator 102 marks at least a portion of the medical exam according to a criterion identified by the user. The criterion may be, for example, an identifier or a characteristic associated with a type of medical presentation to be created. For example, the presentation creator 102 may mark the medical exam according to the user's indication via the user interface 126 that the medical exam should be included in a medical presentation on the brain. Additionally or alternatively, the example medical presentation creator 102 marks at least a portion of the medical exam according to a criterion automatically selected and/or determined by the example presentation creator 102. As used herein, marking at least a portion of the medical exam includes any type of indicating and/or specifying that the at least portion of the medical exam is to be included in a medical presentation.

The example medical presentation creator 102 collects the marked portions of the medical exam to be included in a medical presentation according to the criterion identified by the user via the user interface 126. For example, the presentation creator 102 collects the marked portions of the medical exam to be included in a medical presentation on the brain.

The example medical presentation creator 102 prepares, automatically, a medical presentation for the user as the user continues to review additional medical exams. For example, the user may review a first medical exam and indicate via the user interface 126 that the example presentation creator 102 mark the first medical exam to be included in a medical presentation on the heart. Additionally, the user may annotate the first medical exam to indicate its inclusion in a medical presentation on the heart at, for example, a later viewing. The user may then review a second medical exam and indicate via the user interface 126 that the example presentation creator 102 mark the second medical exam to be included in a medical presentation on the brain, for example. Additionally, the user may annotate the second medical exam to indicate its inclusion in a medical presentation on the brain at, for example, a later viewing. As the user continues review of additional medical exams, the example presentation creator 102 dynamically updates the medical presentations.

The example medical presentation creator 102 gathers the marked portions of medical exams to be included in a particular type of medical exam as indicated by the user via the user interface 126, for example. While preparing a medical presentation, the example presentation creator 102 anonymizes the marked portions of the medical exams to be included in the medical presentation. The anonymized portions of the medical exams exclude patient-identifying information, such as name, patient identification number, or birth date, etc.

The example medical presentation creator 102 may display the created medical presentation via an interface, such as the user interface 126 of the workstation 114. Additionally, the example presentation creator 102 may share the medical presentation with one or more additional users for viewing and/or editing. Further, the example presentation creator 102 may send the medical presentation to the data center 112 to be stored for later viewing.

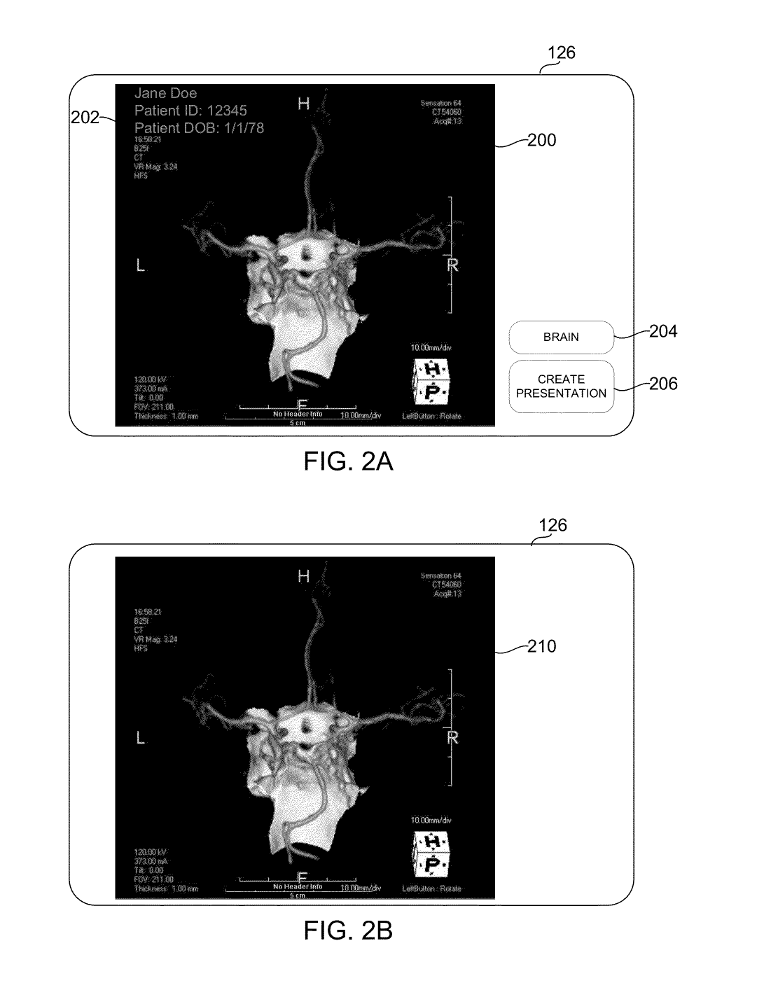

FIG. 2A illustrates an example patient medical image 200 collected by the example healthcare system 100 to be included in a medical presentation created using the example medical presentation creator 102 of FIG. 1. The example patient medical image 200 is selected and displayed using, for example, the user interface 126 of the workstation 114 of FIG. 1. The example presentation creator 102 accesses the example medical image 200 stored in, for example, the data center 112, and presents the medical image 200 for review by a user. The user interface 126 of FIG. 1 displays the medical image 200 as it was originally created (i.e., with patient identifying information 202 shown on the image 200).

The user interface 126 allows the user to enter and/or select a type of medical presentation relevant to the medical image 200 in an input box 204. For example, the medical image 200 is a CT scan of a brain and thus, the user may wish to identify the medical image 200 as relevant to a presentation on the brain in the input box 204. The user interface 126 presents a button 206 that allows the user to indicate that it would like to include the medical image 200 in the selected type of medical presentation. Additionally, the user may annotate the medical image 200 indicating its inclusion in a medical presentation. The presentation creator 102 marks the medical image 200 according to the selected type of medical presentation. In an alternative example, the presentation creator 102 marks the medical image 200 according to a criterion automatically selected and/or determined by the presentation creator 102.

FIG. 2B illustrates an example patient medical image 210 included in a medical presentation created by the example presentation creator 102 of FIG. 1. In the example of FIG. 2A, the presentation creator 102 marked the medical image 200 according to the selected type of medical presentation, for example, a medical presentation related to brain images. The example presentation creator 102 prepares, automatically, a medical presentation for the user as the user continues an exam review. For example, the user may review additional medical exams and mark them according to the same and/or different type of medical presentation as the medical image 200. The example presentation creator 102 may dynamically update the medical presentation as the user continues his or her review.

The example presentation creator 102 gathers the medical exams that were marked according to the same type of medical presentation. For example, the presentation creator 102 gathers the medical exams, including the medical image 200, that were marked to be included in a medical presentation of the brain. In preparing the medical presentation, the example presentation creator 102 anonymizes the medical exams to be included in the presentation. For example, after the presentation creator 102 creates a medical presentation on the brain, the user interface 126 of FIG. 1 displays the medical image 210 without the patient identifying information 202 of FIG. 2A.

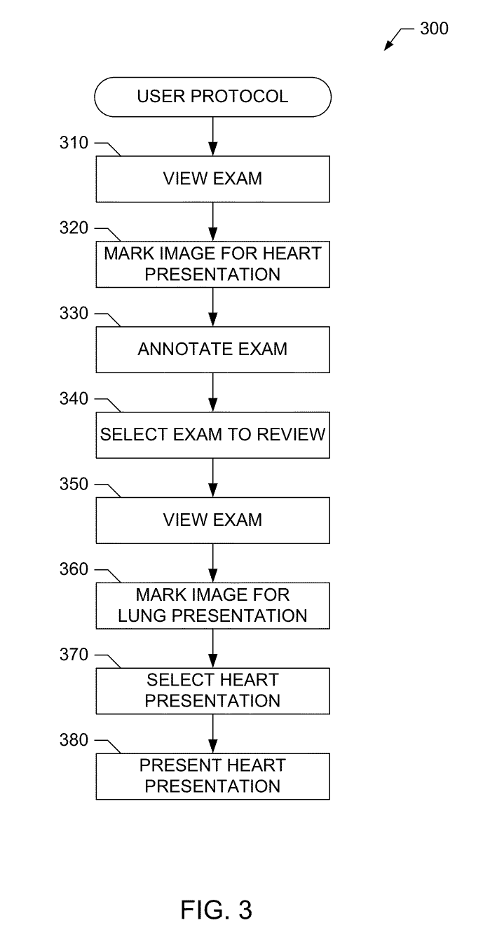

FIG. 3 is a flow diagram illustrating an example user protocol 300 for using the example presentation creator 102 of FIG. 1. At block 310, a user views a first medical exam via a viewer (for example, the user interface 126 of FIG. 1). Alternatively, the user may view the first medical exam via a display associated with the PACS 108 of FIG. 1, for example. The user may find the first medical exam to be of interest. For example, the user may want to include some or all of the first medical exam in a medical presentation on the heart. At block 320, the user instructs the example presentation creator 102 of FIG. 1 to mark the first medical exam for inclusion in a heart presentation. At block 330, the user annotates the first medical exam indicating its inclusion in a heart presentation. Thus, if the user views the first medical exam at a later time, the user will be aware of the exams use in a medical presentation. At block 340, the user may select, via a viewer, a second medical exam to review. At block 350, the user views the second medical exam via, for example, the user interface 126 of FIG. 1. The user may find the second medical exam to be of interest. For example, the user may want to include some or all of the second medical exam in a medical presentation on the lungs. At block 370, the user may instruct the example presentation creator 102 to create a presentation on the heart. The presentation creator 102 gathers the exams marked to be included in a heart presentation, anonymizes the exams, creates a medical presentation on the heart, and presents it for the user via a viewer. Alternatively, a presentation may be dynamically created in the background as the user is conducting a review. At block 380, the user presents the medical presentation on the heart at, for example, a teaching conference.

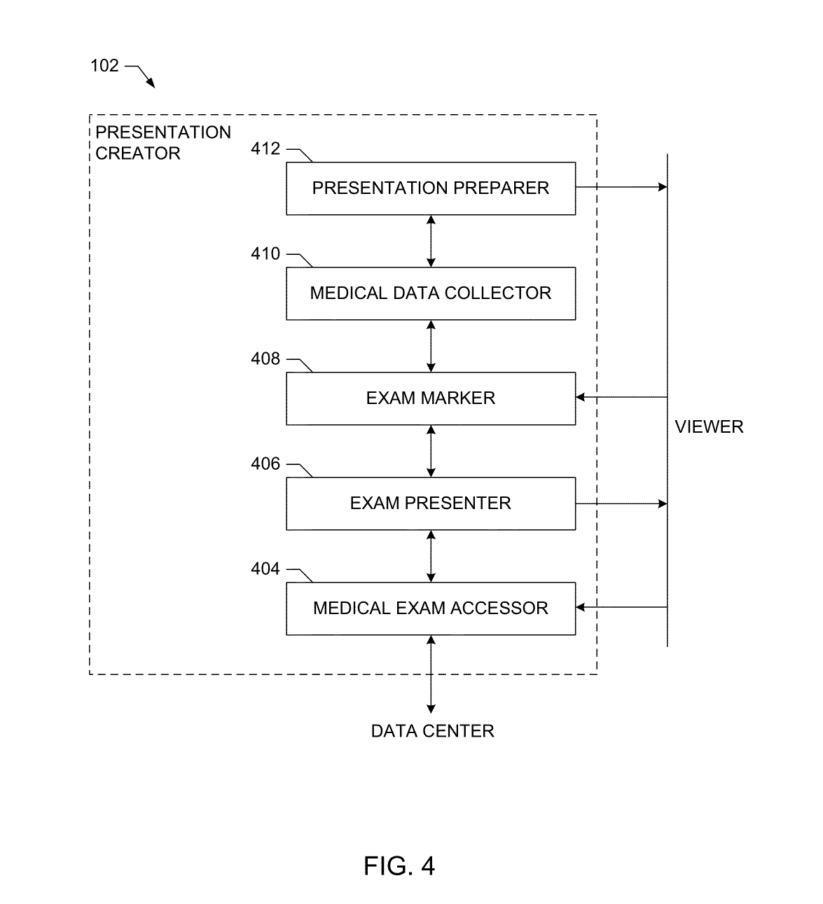

FIG. 4 shows a block diagram of the example medical presentation creator 102 of FIG. 1. The example presentation creator 102 includes a medical exam accessor 404, an exam presenter 406, an exam marker 408, a medical data collector 410, and a presentation preparer 412. The medical exam accessor 404 interfaces with a viewer, such as the user interface 126 of FIG. 1, and the data center 112 of FIG. 1. A user selects a medical exam to be accessed via the viewer. In an alternative example, the medical exam is automatically selected from a worklist associated with the user. The example medical exam accessor 404 accesses the selected medical exam via, for example, the data center 112 where the exam is stored. Once accessed, the example exam presenter 406 presents the medical exam for review by the user via, for example, the user interface 126 of FIG. 1. In an alternative example, the exam presenter 406 presents the medical exam via a display associated with the PACS 108 of FIG. 1. In another alternative example, the exam presenter 406 presents the medical exam on the user interface 126 via a display associated with the PACS 108 of FIG. 1.

The example exam marker 408 marks at least a portion of the medical exam according to a criterion identified by the user. The criterion may be, for example, an identifier or a characteristic associated with a type of medical presentation to be created. For example, the exam marker 408 may mark the medical exam according to the user's indication via a viewer, such as the user interface 126, that the medical exam should be included in a medical presentation on the brain. In an alternative example, the exam marker 408 marks at least a portion of the medical exam according to a criterion automatically selected and/or determined by the presentation creator 102. Additionally, the example exam marker 408 allows the user to annotate the medical exam to indicate its inclusion in a medical presentation.

The example medical data collector 410 collects the marked portions of the medical exam to be included in a medical presentation according to the criterion identified by the user via the viewer. For example, the medical data collector 410 collects the marked portions of the medical exam to be included in a medical presentation on the brain.

The example presentation preparer 412 prepares, automatically, a medical presentation for the user as the user continues to review additional medical exams. For example, the user may review a first medical exam and indicate via the viewer that the example exam marker 408 mark the first medical exam to be included in a medical presentation on the heart. The user may then review a second medical exam and indicate via the viewer that the example exam marker 408 mark the second medical exam to be included in a medical presentation on the brain. As the user continues review, the example presentation preparer 412 dynamically updates the medical presentations.

In an alternative example, the user may review a plurality of medical exams and the example exam marker 408 marks the exams to be included in a presentation as indicated by the user during review. Upon completion of his or her exam review, the user may instruct the example presentation preparer 412 to prepare a medical presentation using all the marked exams. The example medical data collector 410 then collects all marked exams to be included in a medical presentation prepared by the example presentation preparer 412.

While preparing a medical presentation, the example presentation preparer 412 anonymizes the marked portions of the medical exams to be included in the medical presentation. The anonymized portions of the medical exams exclude patient-identifying information, such as name, patient identification number, or birth date, etc.

The example presentation preparer 412 may display the created medical presentation via the viewer, such as the user interface 126 of the workstation 114 of FIG. 1. Additionally, the example presentation preparer 412 may share the medical presentation with one or more additional users for viewing and/or editing. Additionally or alternatively, the example presentation preparer 412 may send the medical presentation to the data center 112 to be stored for later viewing.

The medical exam accessor 404, exam presenter 406, exam marker 408, medical data collector 410, and presentation preparer 412 can be implemented in software, hardware, firmware, and/or a combination of these elements. The medical exam accessor 404, exam presenter 406, exam marker 408, medical data collector 410, and presentation preparer 412 can be implemented separately and/or combined in various forms. The medical exam accessor 404, exam presenter 406, exam marker 408, medical data collector 410, and presentation preparer 412 can be implemented as a set of instructions/routines forming machine executable code stored on a machine accessible medium for execution by a computing/processing device, for example.

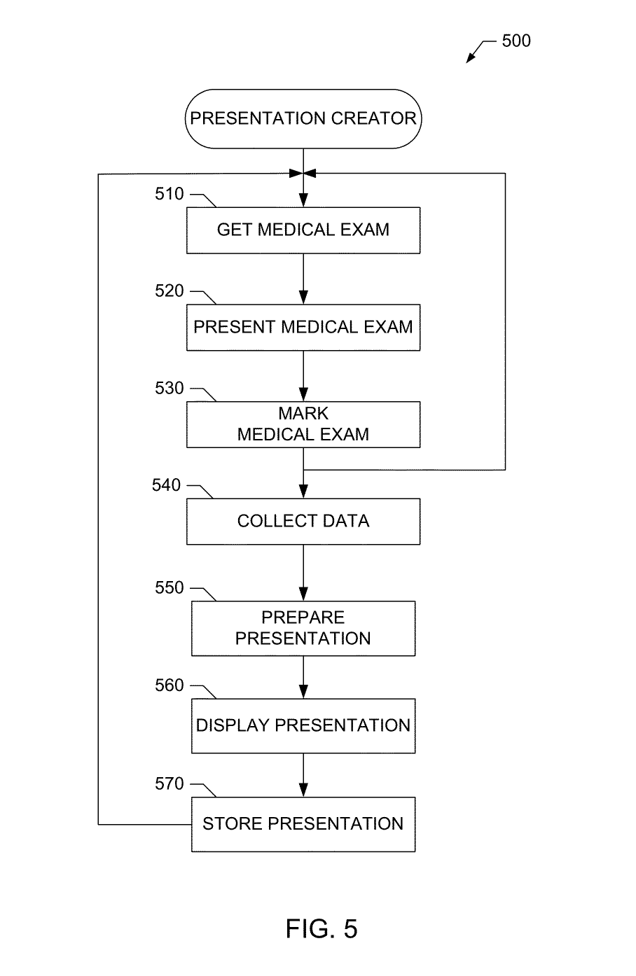

FIG. 5 illustrates a flow diagram for an example method 500 of implementing the example medical presentation creator 102 of FIG. 4. The example process(es) of FIG. 5 can be performed using a processor, a controller and/or any other suitable processing device. For example, the example process(es) of FIG. 5 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIG. 5 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIG. 5 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIG. 5 can be implemented manually or as any combination(s) of any of the foregoing techniques, for example, any combination of firmware, software, discrete logic and/or hardware. Further, although the example process(es) of FIG. 5 are described with reference to the flow diagram of FIG. 5, other methods of implementing the process(es) of FIG. 5 can be employed. For example, the order of execution of the blocks can be changed, and/or some of the blocks described can be changed, eliminated, sub-divided, or combined. Additionally, any or all of the example process(es) of FIG. 5 can be performed sequentially and/or in parallel by, for example, separate processing threads, processors, devices, discrete logic, circuits, etc.

FIG. 5 illustrates a flow diagram for an example method 500 of implementing the example medical presentation creator 102 of FIG. 4. At block 510, a medical exam is accessed by the example medical exam accessor 404. The medical exam accessor 404 interfaces with a viewer, such as the user interface 126 of FIG. 1, and the data center 112 of FIG. 1. A user selects a medical exam to be accessed via the viewer. In an alternative example, the medical exam is automatically selected from a worklist associated with the user. The example medical exam accessor 404 accesses the selected medical exam via, for example, the data center 112 where the exam is stored.

At block 520, the example exam presenter 406 presents the medical exam for review by the user via, for example, the user interface 126 of FIG. 1. In an alternative example, the exam presenter 406 presents the medical exam via a display associated with the PACS 108 of FIG. 1. In another alternative example, the exam presenter 406 presents the medical exam on the user interface 126 via a display associated with the PACS 108 of FIG. 1.

At block 530, the example exam marker 408 marks at least a portion of the medical exam according to a criterion identified by the user. The criterion may be, for example, an identifier or a characteristic associated with a type of medical presentation to be created. For example, the exam marker 408 may mark the medical exam according to the user's indication via a viewer, such as the user interface 126, that the medical exam should be included in a medical presentation on the brain. In an alternative example, the exam marker 408 marks at least a portion of the medical exam according to a criterion automatically selected and/or determined by the example presentation creator 102 of FIG. 1. Additionally, the example exam marker 408 allows the user to annotate the medical exam to indicate its inclusion in a medical presentation.

At block 540, the example medical data collector 410 collects the marked portions of the medical exam to be included in a medical presentation according to the criterion identified by the user via the viewer. For example, the medical data collector 410 collects the marked portions of the medical exam to be included in a medical presentation on the brain.

At block 550, the example presentation preparer 412 prepares, automatically, a medical presentation for the user as the user continues to review additional medical exams (i.e., control returns to block 510 after block 530). For example, the user may review a first medical exam and indicate via the viewer that the example exam marker 408 mark the first medical exam to be included in a medical presentation on the heart. The user may then review a second medical exam and indicate via the viewer that the example exam marker 408 mark the second medical exam to be included in a medical presentation on the brain. As the user continues review, the example presentation preparer 412 dynamically updates the medical presentations.

In an alternative example, the user may review a plurality of medical exams and the example exam marker 408 marks the exams to be included in a presentation as indicated by the user during review. Upon completion of his or her exam review, the user may instruct the example presentation preparer 412 to prepare a medical presentation using all the marked exams. The example medical data collector 410 then collects all marked exams to be included in a medical presentation prepared by the example presentation preparer 412.

While preparing a medical presentation, the example presentation preparer 412 anonymizes the marked portions of the medical exams to be included in the medical presentation. The anonymized portions of the medical exams exclude patient-identifying information, such as name, patient identification number, or birth date, etc.

At block 560, the example presentation preparer 412 may display the created medical presentation via the viewer, such as the user interface 126 of the workstation 114 of FIG. 1. Additionally, the example presentation preparer 412 may share the medical presentation with one or more additional users for viewing and/or editing. At block 570, the example presentation preparer 412 may send the medical presentation to the data center 112 to be stored for later viewing.

One or more of the blocks of the method 500 can be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device.

Certain examples can omit one or more of these blocks and/or perform the blocks in a different order than the order listed. For example, some steps may not be performed in certain examples. As a further example, certain steps can be performed in a different temporal order, including simultaneously, than listed above.

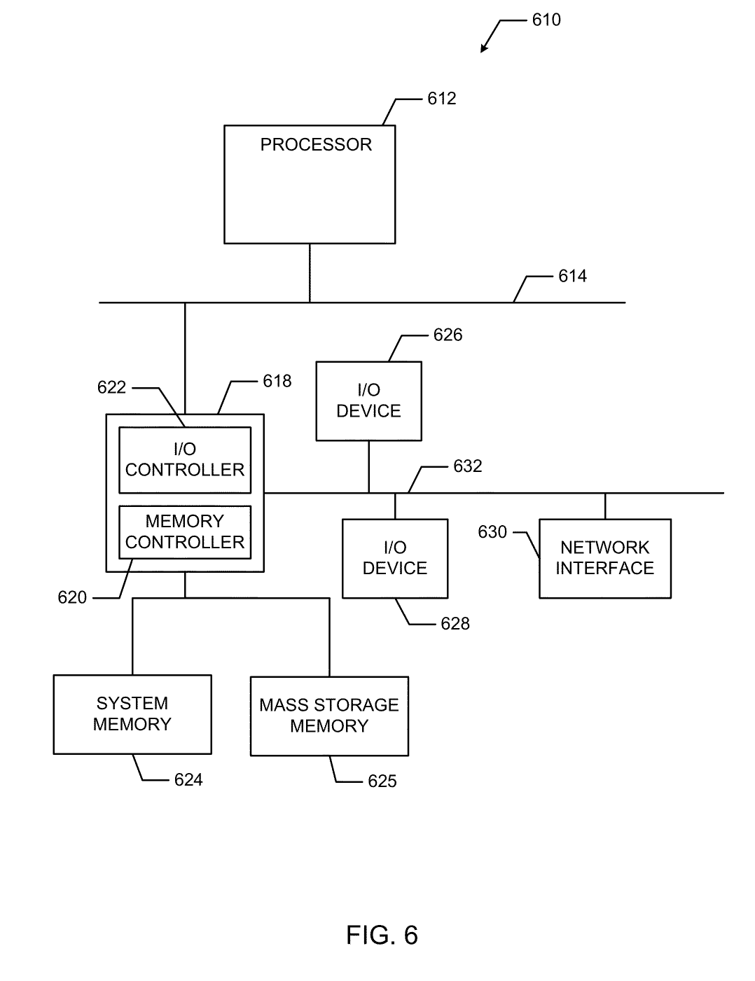

FIG. 6 is a block diagram of an example processor system 610 that can be used to implement systems and methods described herein. As shown in FIG. 6, the processor system 610 includes a processor 612 that is coupled to an interconnection bus 614. The processor 612 can be any suitable processor, processing unit, or microprocessor, for example. Although not shown in FIG. 6, the system 610 can be a multi-processor system and, thus, can include one or more additional processors that are identical or similar to the processor 612 and that are communicatively coupled to the interconnection bus 614.

The processor 612 of FIG. 6 is coupled to a chipset 618, which includes a memory controller 620 and an input/output (“I/O”) controller 622. As is well known, a chipset typically provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 can include any desired type of volatile and/or non-volatile memory such as, for example, static random access memory (SRAM), dynamic random access memory (DRAM), flash memory, read-only memory (ROM), etc. The mass storage memory 625 can include any desired type of mass storage device including hard disk drives, optical drives, tape storage devices, etc.

The I/O controller 622 performs functions that enable the processor 612 to communicate with peripheral input/output (“I/O”) devices 626 and 628 and a network interface 630 via an I/O bus 632. The I/O devices 626 and 628 can be any desired type of I/O device such as, for example, a keyboard, a video display or monitor, a mouse, etc. The network interface 630 can be, for example, an Ethernet device, an asynchronous transfer mode (“ATM”) device, an 802.11 device, a DSL modem, a cable modem, a cellular modem, etc. that enables the processor system 610 to communicate with another processor system.

While the memory controller 620 and the I/O controller 622 are depicted in FIG. 6 as separate blocks within the chipset 618, the functions performed by these blocks can be integrated within a single semiconductor circuit or may be implemented using two or more separate integrated circuits.

Thus, certain examples provide for improved self-monitoring of medication intake by patients, especially, for example, elderly adults, resulting in fewer instances of under or overdosing. Additionally, certain examples provide for improved monitoring of patient medication intake by healthcare providers via a healthcare system, resulting in reduced stress on the healthcare providers. Furthermore, certain examples can be advantageously customized to analyze a variety of medications needed to treat a wide range of medical conditions.

Certain examples contemplate methods, systems and computer program products on any machine-readable media to implement functionality described above. Certain examples can be implemented using an existing computer processor, or by a special purpose computer processor incorporated for this or another purpose or by a hardwired and/or firmware system, for example.

One or more of the components of the systems and/or steps of the methods described above can be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device. Certain examples of the present invention can omit one or more of the method steps and/or perform the steps in a different order than the order listed. For example, some steps cannot be performed in certain examples of the present invention. As a further example, certain steps can be performed in a different temporal order, including simultaneously, than listed above.

Certain examples include computer-readable media for carrying or having computer-executable instructions or data structures stored thereon. Such computer-readable media can be any available media that can be accessed by a general purpose or special purpose computer or other machine with a processor. By way of example, such computer-readable media can comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention can be practiced in a networked environment using logical connections to one or more remote computers having processors. Logical connections can include a local area network (LAN) and a wide area network (WAN) that are presented here by way of example and not limitation. Such networking environments are commonplace in office-wide or enterprise-wide computer networks, intranets and the Internet and can use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention can also be practiced in distributed computing environments where tasks are performed by local and remote processing devices that are linked (either by hardwired links, wireless links, or by a combination of hardwired or wireless links) through a communications network. In a distributed computing environment, program modules can be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory can include read only memory (ROM) and random access memory (RAM). The computer can also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method for creating a medical presentation, said method comprising:
accessing a medical exam;
presenting the medical exam for review by a user;
marking at least a portion of the medical exam according to a criterion identified by the user;
collecting the marked portion of the medical exam to be included in a presentation according to the criterion; and
preparing, automatically, a presentation for the user as the user continues exam review, the presentation including the marked portion of the medical exam, wherein the marked portion of the medical exam is anonymized, the presentation to be dynamically updated as the user continues review.

2. The computer-implemented method of claim 1, wherein the medical exam is automatically selected from a worklist associated with a user.

3. The computer-implemented method of claim 1, wherein the medical exam includes at least one of an exam worklist, a patient historical palette, a report, or a medical image.

4. The computer-implemented method of claim 1, wherein the criterion is at least one of an identifier or characteristic.

5. The computer-implemented method of claim 1, wherein the criterion is automatically selected.

6. The computer-implemented method of claim 1, further comprising annotating the medical exam to indicate its inclusion in a medical presentation.

7. The computer-implemented method of claim 1, wherein the anonymized marked portion of the medical exam includes non-identifying patient medical data.

8. The computer-implemented method of claim 1, further comprising displaying the presentation via an interface.

9. The computer-implemented method of claim 1, further comprising sharing the presentation with one or more additional users for viewing and editing.

10. A tangible computer-readable medium comprising instructions that, when executed, cause a computing device to at least:
access a medical exam;
present the medical exam for review by a user;
mark at least a portion of the medical exam according to a criterion identified by the user;
collect the marked portion of the medical exam to be included in a presentation according to the criterion; and
prepare, automatically, a presentation for the user as the user continues exam review, the presentation including the marked portion of the medical exam, wherein the marked portion of the medical exam is anonymized, the presentation to be dynamically updated as the user continues review.

11. The tangible computer-readable medium of claim 10, wherein the medical exam is automatically selected from a worklist associated with the user.

12. The tangible computer-readable medium of claim 10, wherein the medical exam includes at least one of an exam worklist, a patient historical palette, a report, or a medical image.

13. The tangible computer-readable medium of claim 10, wherein the criterion is at least one of an identifier or characteristic.

14. The tangible computer-readable medium of claim 10, wherein the criterion is automatically selected.

15. The tangible computer-readable medium of claim 10, further comprising instructions that, when executed, cause a computing device to at least annotate the medical exam to indicate its inclusion in a medical presentation.

16. The tangible computer-readable medium of claim 10, wherein the anonymized marked portion of the medical exam includes non-identifying patient medical data.

17. The tangible computer-readable medium of claim 10, further comprising instructions that, when executed, cause a computing device to at least display the presentation via an interface.

18. The tangible computer-readable medium of claim 10, further comprising instructions that, when executed, cause a computing device to at least share the presentation with one or more additional users for viewing and editing.

19. A medical presentation creator system, said system comprising:
a medical exam accessor to access a medical exam;
an exam presenter to present the medical exam for review by a user;
an exam marker to mark at least a portion of the medical exam according to a criterion identified by the user;
a medical data collector to collect the marked portion of the medical exam to be included in a presentation according to the criterion; and
a presentation preparer to prepare, automatically, a presentation for the user as the user continues exam review, the presentation including the marked portion of the medical exam, wherein the marked portion of the medical exam is anonymized, the presentation to be dynamically updated as the user continues review.

20. The system of claim 19, wherein the medical exam is automatically selected from a worklist associated with the user.

21. The system of claim 19, wherein the medical exam includes at least one of an exam worklist, a patient historical palette, a report, or a medical image.

22. The system of claim 19, wherein the criterion is at least one of an identifier or characteristic.

23. The system of claim 19, wherein the criterion is automatically selected.

24. The system of claim 19, wherein the exam marker annotates the medical exam to indicate its inclusion in a medical presentation.

25. The system of claim 19, wherein the anonymized marked portion of the medical exam includes non-identifying patient medical data.

26. The system of claim 19, further comprising a presentation displayer to display the presentation via an interface.

27. The system of claim 19, further comprising a presentation sharer to share the presentation with one or more additional users for viewing and editing.
